(19) United States
(12) Patent Application Publication
(10) Pub. No.: US 2026/0042002 A1
(43) Pub. Date: Feb. 12, 2026

(54) JOYSTICK STRUCTURE

(71) Applicant: CHENG UEI PRECISION INDUSTRY CO., LTD., New Taipei City (TW)

(72) Inventors: TSUNG-SHIH LEE, New Taipei City (TW); YI HSU, New Taipei City (TW)

(21) Appl. No.: 18/984,977

(22) Filed: Dec. 17, 2024

(30) Foreign Application Priority Data
Aug. 9, 2024 (CN) 202421938089.1

(51) Int. Cl. A63F 13/24

(52) U.S. Cl. CPC A63F 13/24

(57) ABSTRACT

A joystick structure includes a key cap, a base, a steering stick unit disposed to a bottom surface of the base, a circuit board and a cable. The key cap has a head portion. A bottom surface of the head portion extends downward to form a fastening portion. The base is disposed to a bottom surface of the key cap. The base has a main portion. A top of the main portion extends upward to form a hollow surrounding portion. The fastening portion is fastened in the surrounding portion. The base has a through hole. The steering stick unit is mounted on a top surface of the circuit board. One end of the cable is integrally molded in the fastening portion. The other end of the cable passes through the through hole, and then the other end of the cable is electrically connected with the circuit board.

### BACKGROUND OF THE INVENTION

### Field of the Invention

The present invention generally relates to a joystick structure, and more particularly to a joystick structure which is capable of simplifying an assembling process and reducing a manufacturing cost.

### Description of Related Art

In game controllers, joysticks of the game controllers are frequently used as operation keys. The joystick is generally operated by a thumb of a user.

A conventional game controller includes a joystick and a main circuit board. The joystick includes a joystick body and a joystick cap. An upper portion of the joystick cap has a flexible printed circuit board with a sensing function. The main circuit board has a touch-sensitive element. The flexible printed circuit board is connected with the touch-sensitive element of the main circuit board. When a finger of a user touches the flexible printed circuit board, the flexible printed circuit board detects an electric signal variation and transmits the electric signal variation to the touch-sensitive element. The main circuit board determines a touching action according to the electric signal variation of the touch-sensitive element. The main circuit board sends a preset command to a game console according to the touching action. The preset command is corresponding to the touching action. The game console is corresponding to the conventional game controller.

However, a touching element of the flexible printed circuit board of the conventional game controller is adhered to the upper portion of the joystick cap by a bonding medium. For example, the touching element of the flexible printed circuit board of the conventional game controller is adhered to the upper portion of the joystick cap by a double-sided adhesive, so an assembling process and a manufacturing cost of the conventional game controller are increased. Moreover, the above-mentioned upper portion of the joystick cap is made of an insulating material, so the flexible printed circuit board with a sensing function is needed, and a manufacturing cost of the flexible printed circuit board is increased.

Thus, it is essential to provide an innovative joystick structure which is capable of simplifying an assembling process and reducing a manufacturing cost.

### BRIEF SUMMARY OF THE INVENTION

An object of the present invention is to provide a joystick structure which is capable of simplifying an assembling process and reducing a manufacturing cost. The joystick structure includes a key cap, a base, a steering stick unit disposed to a bottom surface of the base, a circuit board and a cable. The key cap has a head portion. A middle of a bottom surface of the head portion extends downward to form a fastening portion. The base is disposed to a bottom surface of the key cap. The base has a main portion. A middle of a top of the main portion extends upward to form a hollow surrounding portion. The fastening portion is fastened in the surrounding portion. An inner periphery of a junction between the main portion and the surrounding portion protrudes downward and then extends inward to form a connecting portion. A bottom surface of the fastening portion abuts against a top surface of the connecting portion. The base has a through hole penetrating through the top surface and a bottom surface of the connecting portion. The steering stick unit is mounted on a top surface of the circuit board. One end of the cable is integrally molded in the fastening portion by an injection molding technology. The other end of the cable passes through the through hole, and then the other end of the cable is electrically connected with the circuit board.

Another object of the present invention is to provide a joystick structure. The joystick structure includes a key cap made of a conductive soft plastic material, a cable, a base, a steering stick unit and a circuit board. One end of the cable is integrally molded in the key cap by an injection molding technology. The base is disposed to a bottom surface of the key cap. The base has a main portion. A middle of a top of the main portion extends upward to form a surrounding portion. The surrounding portion is a hollow cylinder shape. An inner periphery of a junction between the main portion and the surrounding portion protrudes downward and then extends inward to form a connecting portion. The base has a through hole penetrating through a top surface and a bottom surface of the connecting portion. The other end of the cable passes through the through hole. The steering stick unit is disposed to a bottom surface of the base. The steering stick unit is mounted on a top surface of the circuit board. The other end of the cable is electrically connected with the circuit board.

Another object of the present invention is to provide a joystick structure. The joystick structure includes a key cap, a base, a steering stick unit disposed to a bottom surface of the base, a circuit board and a cable. The key cap has a head portion. A middle of a bottom surface of the head portion extends downward to form a fastening portion. The key cap is made of a conductive soft plastic material. The base is disposed to a bottom surface of the key cap. The base has a main portion. A middle of a top of the main portion extends upward to form a hollow surrounding portion. The fastening portion is fastened in the surrounding portion. An inner periphery of a junction between the main portion and the surrounding portion protrudes downward and then extends inward to form a connecting portion. A bottom surface of the fastening portion abuts against a top surface of the connecting portion. The base has a through hole penetrating through the top surface and a bottom surface of the connecting portion. The steering stick unit is mounted on a top surface of the circuit board. One end of the cable is integrally molded in the fastening portion by an injection molding technology. The other end of the cable passes through the through hole, and then the other end of the cable is electrically connected with the circuit board.

As described above, the key cap and the cable of the joystick structure are integrally formed by the injection molding technology. The cable is integrated with the key cap, and the cable is disposed in the key cap by virtue of an integral injection molding technology. The key cap is made of the conductive soft plastic material which includes a conductive material and a soft plastic material, so the head portion of the key cap and the fastening portion of the key cap have a conductive function. As a result, the joystick structure is capable of simplifying the assembling process and reducing the manufacturing cost.

### BRIEF DESCRIPTION OF THE DRAWINGS

The present invention will be apparent to those skilled in the art by reading the following description, with reference to the attached drawings, in which:

FIG. 1 is a perspective view of a joystick structure in accordance with a preferred embodiment of the present invention;

FIG. 2 is an exploded view of the joystick structure of FIG. 1;

FIG. 3 is a partially exploded view that shows a base, a key cap together with a cable of the joystick structure of FIG. 1;

FIG. 4 is a perspective view of the base of the joystick structure of FIG. 2;

FIG. 5 is a diagrammatic drawing of the joystick structure according to the preferred embodiment of the present invention; and

FIG. 6 is a sectional view of the joystick structure along a line VI-VI of FIG. 5.

### DETAILED DESCRIPTION OF THE INVENTION

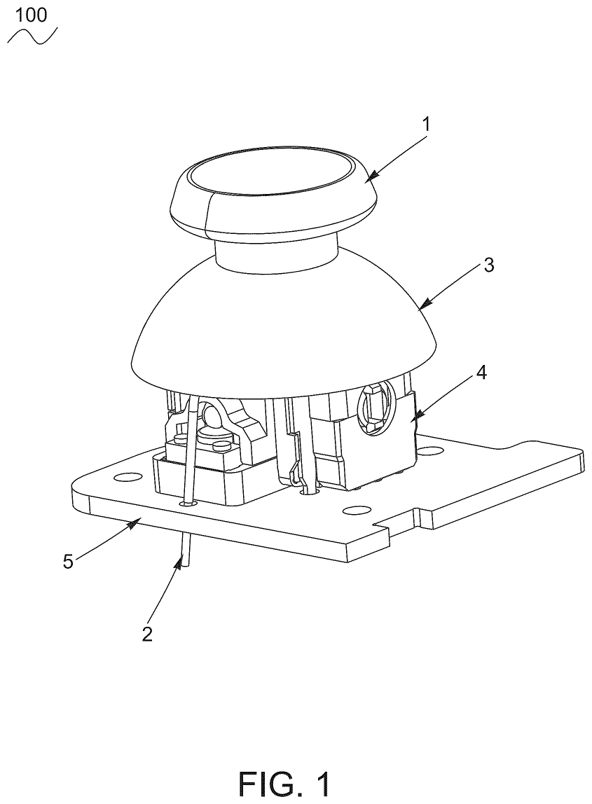

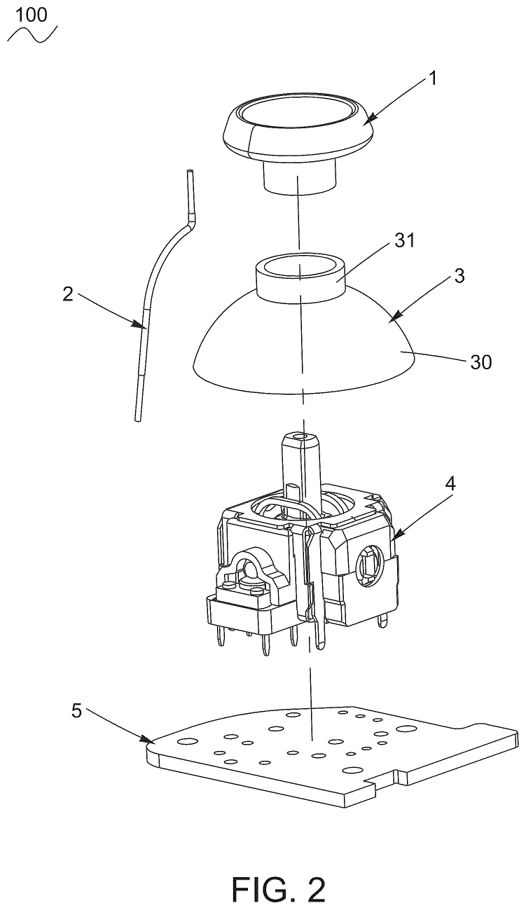

With reference to FIG. 1 and FIG. 2, a joystick structure 100 in accordance with a preferred embodiment of the present invention is shown. The joystick structure 100 includes a key cap 1, a cable 2, a base 3, a steering stick unit 4 and a circuit board 5. One end of the cable 2 is fastened in the key cap 1. The other end of the cable 2 is connected with the circuit board 5. The base 3 is disposed to a bottom surface of the key cap 1. The steering stick unit 4 is disposed to a bottom surface of the base 3. The steering stick unit 4 is mounted on a top surface of the circuit board 5.

In the preferred embodiment, the key cap 1 and the cable 2 are integrally formed by an injection molding technology. The cable 2 is integrated with the key cap 1. The cable 2 is disposed in the key cap 1 by virtue of an integral injection molding technology, so an assembling process of the joystick structure 100 is simplified, and a manufacturing cost of the joystick structure 100 is reduced.

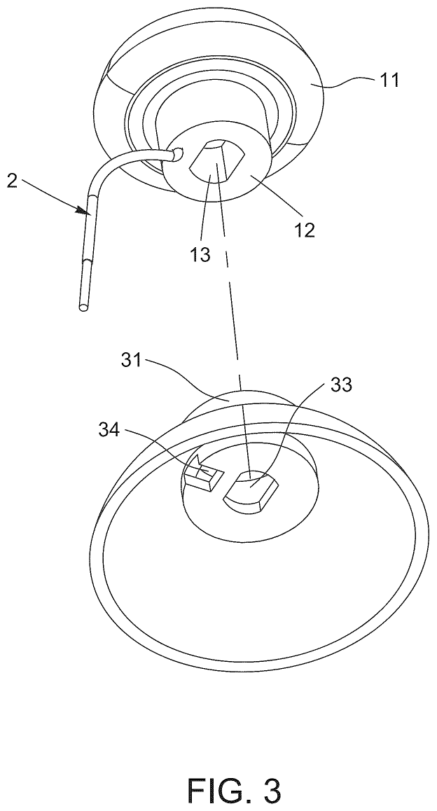

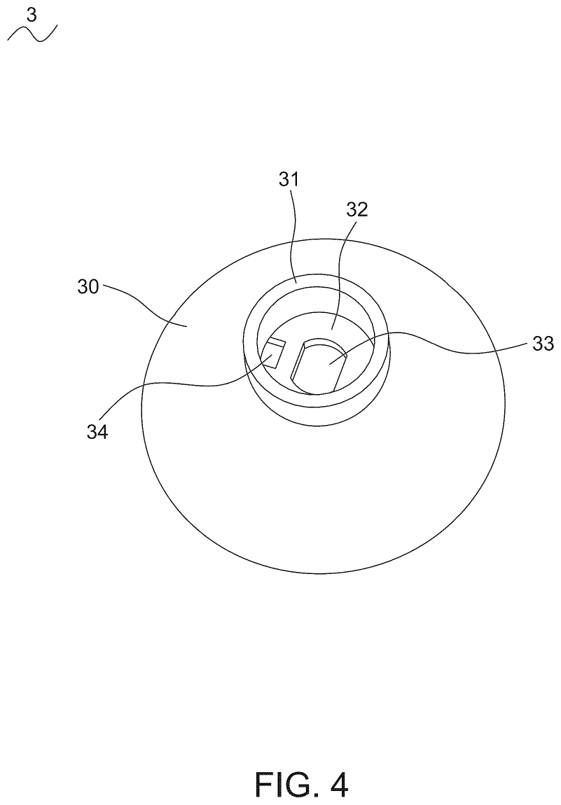

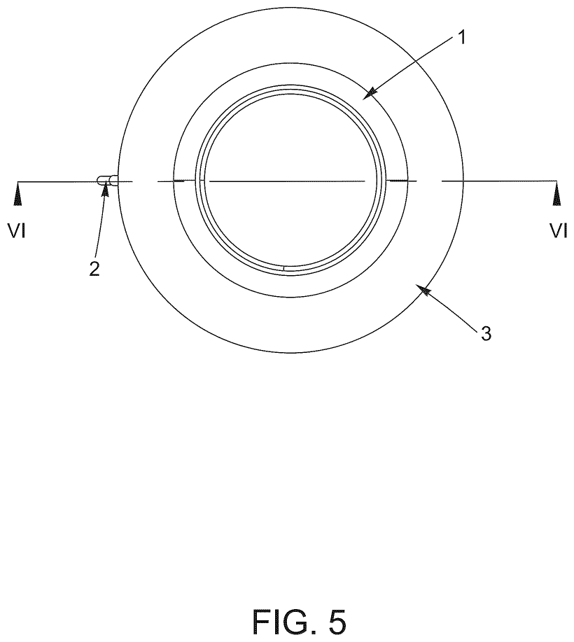

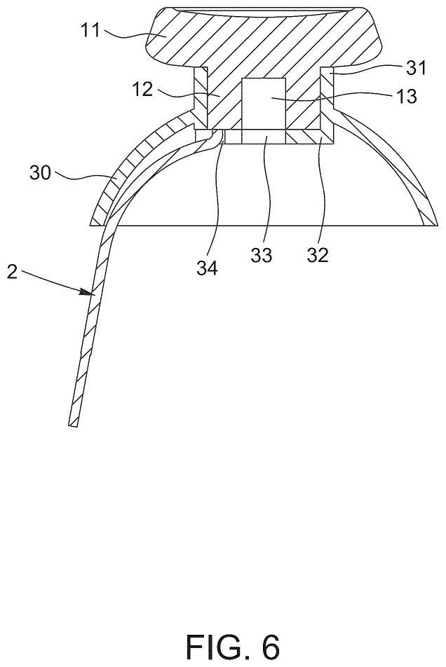

Referring to FIG. 3 to FIG. 6, the key cap 1 has a head portion 11, a fastening portion 12 and a first location hole 13. A middle of a bottom surface of the head portion 11 extends downward to form the fastening portion 12. One end of the cable 2 is integrally molded in the fastening portion 12 of the key cap 1 by the injection molding technology. In a concrete implementation, the one end of the cable 2 extends into the head portion 11. The fastening portion 12 is disposed in a corresponding mechanism of the base 3. The key cap 1 defines the first location hole 13 penetrating through a bottom surface of the fastening portion 12. A top end of the steering stick unit 4 is fastened in the first location hole 13 to realize a location and a fixation between the steering stick unit 4 and the key cap 1.

In the preferred embodiment, the key cap 1 is made of a conductive soft plastic material. The conductive soft plastic material includes a conductive material and a soft plastic material, so the head portion 11 of the key cap 1 and the fastening portion 12 of the key cap 1 have a conductive function. When a finger touches the key cap 1, the circuit board 5 detects a variation of an electrical characteristic of the key cap 1 by the cable 2. For example, the circuit board 5 detects a variation of an electric capacity of the key cap 1 by the cable 2.

The base 3 is a hollow structure. An upper portion of the base 3 is a hollow cylinder shape. The base 3 has a main portion 30, a surrounding portion 31, a connecting portion 32, a second location hole 33 and a through hole 34. A middle of a top of the main portion 30 extends upward to form the hollow surrounding portion 31. The surrounding portion 31 is the hollow cylinder shape. The fastening portion 12 of the key cap 1 is fastened in the surrounding portion 31. An inner periphery of a junction between the main portion 30 and the surrounding portion 31 protrudes downward and then extends inward to form the connecting portion 32. The connecting portion 32 is shown as a ring shape. A bottom surface of the fastening portion 12 of the key cap 1 abuts against a top surface of the connecting portion 32. The base 3 has the second location hole 33 penetrating through the top surface and a bottom surface of the connecting portion 32. The second location hole 33 is corresponding to the first location hole 13 of the key cap 1.

The top end of the steering stick unit 4 passes through the second location hole 33, and then the top end of the steering stick unit 4 is fastened in the first location hole 13 to realize that the steering stick unit 4 and the key cap 1 are located in the base 3, and that the steering stick unit 4 and the key cap 1 are fastened in the base 3. The base 3 has the through hole 34 penetrating through the top surface and the bottom surface of the connecting portion 32. The through hole 34 is formed to one side of the second location hole 33. The other end of the cable 2 passes through the through hole 34, and then the other end of the cable 2 is electrically connected with the circuit board 5.

With reference to FIG. 1 to FIG. 6, when the joystick structure 100 is assembled, at first, the cable 2 is disposed in the key cap 1, and the cable 2 is integrated with the key cap 1 by virtue of the integral injection molding technology. Then, the base 3 is assembled with the key cap 1. Again, the key cap 1 and the base 3 are assembled with the top end of the steering stick unit 4. A bottom end of the steering stick unit 4 is soldered to the top surface of the circuit board 5. The cable 2 is electrically connected with the circuit board 5.

As described above, the key cap 1 and the cable 2 of the joystick structure 100 are integrally formed by the injection molding technology. The cable 2 is integrated with the key cap 1, and the cable 2 is disposed in the key cap 1 by virtue of the integral injection molding technology. The key cap 1 is made of the conductive soft plastic material which includes the conductive material and the soft plastic material, so the head portion 11 of the key cap 1 and the fastening portion 12 of the key cap 1 have the conductive function. As a result, the joystick structure 100 is capable of simplifying the assembling process and reducing the manufacturing cost.

What is claimed is:

1. A joystick structure, comprising:
a key cap having a head portion, a middle of a bottom surface of the head portion extending downward to form a fastening portion;
a base disposed to a bottom surface of the key cap, the base having a main portion, a middle of a top of the main portion extending upward to form a hollow surrounding portion, the fastening portion being fastened in the surrounding portion, an inner periphery of a junction between the main portion and the surrounding portion protruding downward and then extending inward to form a connecting portion, a bottom surface of the fastening portion abutting against a top surface of the connecting portion, the base having a through hole penetrating through the top surface and a bottom surface of the connecting portion;
a steering stick unit disposed to a bottom surface of the base;
a circuit board, the steering stick unit being mounted on a top surface of the circuit board; and
a cable, one end of the cable being integrally molded in the fastening portion by an injection molding technology, the other end of the cable passing through the through hole, and then the other end of the cable being electrically connected with the circuit board.

2. The joystick structure as claimed in claim 1, wherein the key cap defines a first location hole penetrating through the bottom surface of the fastening portion, the base has a second location hole penetrating through the top surface and the bottom surface of the connecting portion, the second location hole is corresponding to the first location hole, the through hole is formed to one side of the second location hole, a top end of the steering stick unit passes through the second location hole, and then the top end of the steering stick unit is fastened in the first location hole.

3. The joystick structure as claimed in claim 1, wherein the connecting portion is shown as a ring shape.

4. The joystick structure as claimed in claim 1, wherein the key cap and the cable are integrally formed by the injection molding technology.

5. The joystick structure as claimed in claim 1, wherein the key cap is made of a conductive soft plastic material.

6. The joystick structure as claimed in claim 5, wherein the conductive soft plastic material includes a conductive material and a soft plastic material, so the head portion of the key cap and the fastening portion of the key cap have a conductive function.

7. A joystick structure, comprising:
a key cap made of a conductive soft plastic material;
a cable, one end of the cable being integrally molded in the key cap by an injection molding technology;
a base disposed to a bottom surface of the key cap, the base having a main portion, a middle of a top of the main portion extending upward to form a surrounding portion, the surrounding portion being a hollow cylinder shape, an inner periphery of a junction between the main portion and the surrounding portion protruding downward and then extending inward to form a connecting portion, the base having a through hole penetrating through a top surface and a bottom surface of the connecting portion, the other end of the cable passing through the through hole;
a steering stick unit disposed to a bottom surface of the base; and
a circuit board, the steering stick unit being mounted on a top surface of the circuit board, the other end of the cable being electrically connected with the circuit board.

8. The joystick structure as claimed in claim 7, wherein the conductive soft plastic material includes a conductive material and a soft plastic material.

9. A joystick structure, comprising:
a key cap having a head portion, a middle of a bottom surface of the head portion extending downward to form a fastening portion, the key cap being made of a conductive soft plastic material;
a base disposed to a bottom surface of the key cap, the base having a main portion, a middle of a top of the main portion extending upward to form a hollow surrounding portion, the fastening portion being fastened in the surrounding portion, an inner periphery of a junction between the main portion and the surrounding portion protruding downward and then extending inward to form a connecting portion, a bottom surface of the fastening portion abutting against a top surface of the connecting portion, the base having a through hole penetrating through the top surface and a bottom surface of the connecting portion;
a steering stick unit disposed to a bottom surface of the base;
a circuit board, the steering stick unit being mounted on a top surface of the circuit board; and
a cable, one end of the cable being integrally molded in the fastening portion by an injection molding technology, the other end of the cable passing through the through hole, and then the other end of the cable being electrically connected with the circuit board.

10. The joystick structure as claimed in claim 9, wherein the key cap defines a first location hole penetrating through the bottom surface of the fastening portion, the base has a second location hole penetrating through the top surface and the bottom surface of the connecting portion, the second location hole is corresponding to the first location hole, the through hole is formed to one side of the second location hole, a top end of the steering stick unit passes through the second location hole, and then the top end of the steering stick unit is fastened in the first location hole.
